(19) United States
(12) Patent Application Publication
(10) Pub. No.: US 2007/0000597 A1
(43) Pub. Date: Jan. 4, 2007

(54) Methods for making high intensity flame resistant composites

(76) Inventors: Kurt Hans Wyss, Chavannes De Bogis (CH); Friedrich V. Pfister, Geneva (CH); Yves Jeanrenaud, Dardagny (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/170,879

(22) Filed: Jun. 30, 2005

(51) Int. Cl. B29C 59/00

(52) U.S. Cl. 156/245; 264/122

(57) ABSTRACT

Methods for making heat- and flame-resistant composites are provided. The composites are suitable for use as construction and furnishing panels and as covers for construction and furnishing panels.

### FIELD OF THE INVENTION

The invention relates to the field of heat- and flame-resistant composites, particularly construction and furnishing panels comprising mixtures of melting and non-melting fibres and silicates.

### BACKGROUND OF THE INVENTION

It is known to make fire-resistant pressure-formed composites from organic non-melting fibres (e.g. cellulose, rayon, lyocell) and silicates (see for example U.S. Pat. No. 5,830,548, U.S. Pat. No. 4,956,217, GB223357 and EP0183393).

A mixture of the non-melting organic fibres is mixed with a silicate solution or dispersion, and laminated under high pressure and heat, resulting in a composite having good heat and flame resistance.

Such composites are used to make laminated structures, such as wall panels, that resist fire and flame. However, after prolonged exposure to fire and flame, such structures become brittle, are subject to bowing, and begin to disintegrate (e.g. holes appear). This causes them to lose their ability to act as a barrier to flame, and also to lose their weight-bearing ability. This may lead to spread of fire, and collapse of walls made using such panels, resulting in further damage and injury.

A need remains for composites that not only resist heat and flame, but which maintain more of their strength and structural integrity after exposure to heat and flame.

### SUMMARY OF THE INVENTION

In a first aspect, the invention provides a heat- and flame-resistant composite comprising:
non-melting fibres;
melting fibres; and
at least one silicate.

In a second aspect, the invention provides a heat- and flame-resistant multi-layer panel comprising:

at least one layer (preferably a surface layer) comprising non-melting fibres, melting fibres, and a silicate.

In a third aspect, the invention provides a heat- and flame-resistant composite comprising:
non-melting fibres;
a serpentine mineral; and
at least one silicate.

In a fourth aspect, the invention provides a process for making a fire-resistant composite, comprising the step:

applying a silicate solution or dispersion to a mixture of a non-melting fibre and a melting fibre.

In a fifth aspect, the invention provides a method for making a fire-resistant composite, comprising the step:

applying a silicate solution or dispersion to a mixture of a non-melting fibre and a melting fibre.

In a sixth aspect, the invention provides a process for making a heat and flame-resistant composite laminate, comprising the steps:
(a) stacking a plurality of composites (preferably sheets) comprising a mixture of non-melting fibres and melting fibres and a silicate, to form a stack; and
(b) applying pressure and optionally heat to the stack to form a laminate.

In a seventh aspect, the invention provides a method for making a heat and flame-resistant composite laminate, comprising the steps:
(a) stacking a plurality of composites (preferably sheets) comprising a mixture of non-melting fibres and melting fibres and a silicate, to form a stack; and
(b) applying pressure and optionally heat to the stack to form a laminate.

In an eighth aspect, the invention provides a process for making a heat and flame-resistant composite laminate, comprising the step:

applying pressure and optionally heat to a stack of sheets comprising a mixture of a non-melting fibre and melting fibre and at least one silicate.

In a ninth aspect, the invention provides a method for making a heat and flame-resistant composite laminate, comprising the step:

applying pressure and optionally heat to a stack of sheets comprising a mixture of a non-melting fibre and melting fibre and at least one silicate.

In a tenth aspect, the invention provides a heat- and flame-resistant panel comprising:

at least one outer layer consisting of a sheet comprising a mixture of non-melting fibres and melting fibres and at least one silicate; and a core layer consisting of a mixture of non-melting fibres and at least one silicate.

In an eleventh aspect, the invention provides a process for making a heat- and flame resistant composite comprising the step:

drying a slurry comprising:
non-melting fibres;
melting fibres;
at least one silicate; and
water.

In a twelfth aspect, the invention provides a method for making a heat- and flame resistant composite comprising the step:

drying a slurry comprising:
non-melting fibres;
melting fibres;
at least one silicate; and
water.

In a thirteenth aspect, the invention provides a process for making a heat- and flame resistant composite comprising the step:

adding a slurry comprising non-melting fibres, melting fibres, at least one silicate and water into a water-miscible solvent, so as to coagulate the composite.

In a fourteenth aspect, the invention provides a method for making a heat- and flame resistant composite comprising the step:

adding a slurry comprising non-melting fibres, melting fibres, at least one silicate and water into a water-miscible solvent, so as to coagulate the composite.

### DETAILED DESCRIPTION OF THE PREFERRED EMBODIMENTS

### Brief Description of the Drawings

FIG. 1 shows an experimental set-up used for evaluating the heat- and flame-resistance of composites of the invention.

All documents mentioned herein are incorporated by reference.

The inventors have surprisingly found that a mixture of non-melting fibres, melting fibres, and at least one silicate provides a composite having excellent heat- and flame-resistance. The composites maintain their structural integrity after exposure to heat- and/or flame. While not wishing to be limited by theory, it is believed that the mixture of non-melting fibre and melting fibre provides a matrix that can hold the composite together, even after the melting fibre has been melted by intense heat. Furthermore, the non-melting fibre is believed to form an absorbing matrix for the melting fibre, thus avoiding dripping of the molten melting fibre when exposed to heat.

Such composites may be advantageously prepared in the form of sheets or papers. For the purposes of the present description, a sheet is a structure having a greater length and breadth than thickness and preferably having a thickness of at or about 0.01 to 5 mm. Such composite sheets may be prepared by forming sheets of mixtures of non-melting fibres and melting fibres. The sheets are then impregnated with a silicate solution or dispersion, and, if desired, calendered, to form composite sheets or papers. In the context of the present application, the expression “applying silicate” means applying the silicate, preferably as a solution or dispersion in water, in such a way that the silicate impregnates or penetrates into the bed of fibres. Preferably the silicate is essentially uniformly distributed through the composite, although concentration gradients may occur, and it is contemplated that silicate concentration may be higher closer to the surfaces, due to uneven penetration and migration during drying.

It is possible to calender the sheet before applying the silicate, and equally possible to calender it both before and after applying the silicate. Such composite sheets may be called “fireskins”. Fireskins according to the invention may be stored in dry form for future use. A fireskin according to the invention preferably has a thickness of not greater than at or about 2 mm, and preferably within the range of at or about 0.01 to 2 mm, more preferably at or about 0.02 to 0.5 mm. Using this impregnation method it is possible to get silicate contents as high as at or about 80 wt %, based on the dry weight of the fireskin. Preferably the silicate content should be at least at or about 65 wt %, based on the dry weight of the fireskin.

The silicate impregnates the fibres, and in the fireskin or the laminate formed therefrom, the silicate is intimately dispersed with the fibres, rather than simply forming a coating on the surface.

Laminates of the invention may be made by stacking fireskins of the invention, and applying pressure and optionally heat. Two or more, preferably between at or about 2 to at or about 200, more preferably at or about 20 to at or about 40 fireskins may be stacked, and subjected to pressure and optionally heat, thus forming a laminate structure. In a preferred embodiment, the sole binding component is silicate, although binder resins, such as phenolic resins may also be added. A preferred pressure is between at or about 50 and 180 bar, more preferably at or about 75 bar, and a preferred temperature is between at or about 140 and 200° C., more preferably at or about 160° C. A good pressure/temperature combination is 160° C. and 75 bar.

The number of fireskins to be stacked will depend on the thickness of the fireskins themselves, and the thickness desired for the final laminate. Usually a reduction in thickness of at or about 4- to 10-fold occurs during pressing (i.e. if the stacked fireskins have a total thickness of 30 mm, the pressed laminate will have a thickness of at or about 3 to 7.5 mm). A preferred number of fireskins for stacking is at or about 20 to at or about 60, more preferably at or about 20 or 40 fireskins.

Alternatively, composites of the invention may be made using a slurry method: a slurry is formed from the melting and non-melting fibres and at least one silicate, in water (preferably at or about 50 to 80 wt % water). The slurry is placed in a mould (usually having a tray-like form) and allowed to dry. The result is a dispersion of fibres (melting and non-melting), essentially homogeneously dispersed in a silicate matrix. This method is preferred if it is desired to have a silicate content in excess of at or about 80 wt %, and as high as 98 wt %, based on the dry weight of the panel. Drying can advantageously be aided by applying a stream of dry air (preferably having a humidity of less than at or about 10%), and/or by heating the moulded slurry to below at or about 100° C., for example to at or about 90° C. Alternatively, the slab may be dried by heating using microwaves. Heating using microwaves results in foaming, which can produce a lightweight cellular silicate panel. After drying, by whatever method, to less than at or about 10 wt % water content, preferably less than at or about 5 wt %, the dried slab can be used as is as a panel, or several of the slabs can be stacked and pressure and optionally heat applied to form a denser laminate.

Alternatively, composites of the invention may be made using a coagulation method: a slurry is formed from the melting and non-melting fibres and at least one silicate, in water (preferably at or about 50 to 80 wt % water). The slurry is added, for example by pouring or spraying, into a water-miscible organic solvent, such as, for example, methanol, ethanol, propanol or mixtures of these. The composite coagulates as a coagulated mass, which can be dried to remove solvent. After drying, the composite may be used as is, or it may be made denser by subjecting it to pressure and optionally heat. The result is a dispersion of fibres (melting and non-melting), essentially homogeneously dispersed in a silicate matrix.

A fireskin according to the invention may be applied as an outer layer on a conventional panel (such as a panel made from cellulose fibre and phenolic or other resin), and laminated, so as to form a heat- and flame-resistant skin on one or both sides of the panel. For example, a fireskin may be applied on one side, or both sides of a core of wood pulp and phenolic resin, or a core of cellulosic paper and phenolic resin.

A fireskin of the invention may also be applied, for example, as an outer layer on a core made of wood, pressboard, moulded or extruded polymer material, concrete or metal.

A fireskin of the invention may also be applied as an outer layer on one or both sides of cellular concrete (also known as aerated concrete or foamed concrete). Cellular concrete is used as a lightweight building material, is made by the injection (or blending) of a pre-formed stable foam into a cement based slurry. A problem with cellular concrete is that it creates dust as the tiny cells of concrete at the surface break. By applying a fireskin, the dust problem is overcome, and an attractive surface is created, increasing the possibilities for decoration of a structure made of cellular concrete. Adherence of the fireskin on the cellular concrete may be from the silicate alone, or an adhesive may be used.

In a particularly preferred embodiment, a fireskin of the invention is used as an outer covering layer on one or both sides of a core made of a panel laminate made using the slurry or coagulation techniques. In this way, a core having a fibre content as low as at or about 2 wt % (i.e. at or about 98 wt % silicate) can be used, and covered on one or both sides with a fireskin. This can give an attractive finish to the core.

When a fireskin of the invention is applied as an outer coating on cellular concrete or on a laminate of the invention or a conventional laminate (comprising, for example, organic binder, such as phenolic binder, and cellulose), it may be applied using an adhesive, for example, adhesives such as phenolic, acrylic, epoxy and melamine resins. Particularly preferred adhesives are those described in U.S. Pat. No. 6,855,432 (DuPont), which are compositions made from admixing starting materials consisting essentially of: (a) 20 to 60 parts by weight of polyethylene; (b) 10 to 30 parts by weight of maleic anhydride grafted polyethylene; (c) 10 to 35 parts by weight of a high impact polystyrene; and (d) 10 to 25 parts by weight of an ethylene-propylene diene rubber compound, where the total amount of components of (a), (b), (c) and (d) in the resin compositions is 100 parts by weight. Also preferred are adhesives such as those sold under the tradename Bynel® (DuPont). Alternatively, silicate itself may act as binding component.

In preferred embodiments, the silicate acts as sole binding component for the fireskin or laminate. While not wishing to be bound by theory, the inventors believe that on application of pressure and optionally heat, the silicate moves towards a glass state, forming a matrix that binds the fibres and the laminate together. It is also possible, although less preferable, to add additional binders, such as organic resins, such as phenolic, acrylic, epoxy and melamine resins. If binders are used in addition to silicate, it is preferred that the additional binders be used in an amount of less than at or about 10 wt %, more preferably less than at or about 2 wt %, based on the dry weight of the fireskin or laminate.

A fireskin of the invention may also be used as a building material as such, for example, for making thin screens or walls, where only a thin barrier is required. It may also be used as a wall covering (“wallpaper”), for window blinds, as a surface for furniture (e.g. table tops, laminated chairs), countertops, surfaces in boats, planes, buses, and camping vehicles. The fireskins of the invention can also be used for lightweight flame and smoke barriers.

The expression “non-melting fibres” encompasses those fibres which carbonise as the temperature is increased, before, or very close to melting. Particularly preferred non-melting fibres include organic non-melting fibres, for example, cellulose fibres (e.g. cotton, wood fibres, linen), aramid fibres (e.g. para-aramid, such as Kevlar®, and meta-aramid, such as Nomex®), polybenzimidazoles, polyimides, polyarenes, rayon (e.g. lyocell), and mixtures of these.

The expression “melting fibres” encompasses those fibres which melt as the temperature is increased and have a range of temperature over which they are fluid, before finally decomposing on further heating. Particularly preferred melting fibres include organic melting fibres, for example, polyester fibres (such as fibres of polybutylene terephthalate, polyethylene terephthalate, etc.), mixed polyetheresters, polyamide fibres (e.g. nylons, such as nylon 6,66, Nylon 6,6, Nylon 6,12, Nylon 4,6, Nylon 6, Nylon 12, Nylon 11), polyolefins (e.g. polyethylene, polypropylene), polyphenylene sulfide (PPS), polyetheretherketone (PEEK), poly(ether ketone ketone) (PEKK), PFA (copolymer of tetrafluoroethylene and perfluorovinylether), FEP (copolymer of tetrafluoroethylene and hexafluoropropylene), melt spun fluorofibres (homopolymer of tetrafluoroethylene), also contemplated are glass or basalt fibres, and mixtures of any of the above-listed fibres.

Both the melting and non-melting fibres used in the composites of the invention are preferably embedded in the textile form of a non-woven structure. Advantageously, the non-melting fibre and the melting fibres are intimately mixed with each other to form a fibre mixture. Preferably they form an essentially homogeneous mixture, in that a sample taken at one part of the fibre mixture will have essentially the same composition of fibre types (ratio of non-melting and melting) as a sample taken at another part of the fibre mixture.

The non-woven may be spun-laced, spun-bonded or a needle-felt. Advantageously, the fibres are “spun laced”, a technology whereby short lengths of fibre (called staple) are formed into a strong, three-dimensional sheet structure, by shooting thousands of high-pressure (up to 14 MPa), needle-like jets of water at a random batting of blended fibres. The jets entangle the fibres into a intertwined textile structure, which is then dried and wound into a non-woven “fabric” roll. Virtually any combination of fibres can be entangled, including, for example, rayon, acrylic, woodpulp, cotton, polyester (such as polybutylene terephthalate, polyethylene terephthalate, etc.), mixed polyetheresters, polyamide fibres (e.g. nylons, such as nylon 6,66, Nylon 6,6, Nylon 6,12, Nylon 4,6, Nylon 6, Nylon 12, Nylon 11), polyolefins (e.g. polyethylene, polypropylene), polyphenylene sulfide (PPS), polyethertherketone (PEEK), and poly(ether ketone ketone) (PEKK), PFA (copolymer of tetrafluoroethylene and perfluorovinylether), FEP (copolymer of tertafluoroethylene and hexafluoropropylene), melt spun fluorofibres (homopolymer of tetrafluoroethylene), glass or basalt fibres, and mixtures of these.

Particularly preferably, spun laced structures of cellulose and polyester are used.

Preferably the melting fibre content is kept below at or about 55 wt %, based on the dry weight of the fibres before treatment with silicate (i.e. the dry weight of the total fibre content), as composites having melting fibre contents above this level may drip molten fibre on exposure to heat or flame, leading to damage to the surroundings and possible spread of fire. Preferably the melting fibre content falls between at or about 10 to 40 wt %, more preferably at or about 25 to 35 wt %, based on the dry weight of the fibres before treatment with silicate (i.e. the dry weight of the total fibre content).

In a preferred embodiment, the melting fibre content is at or about 50 wt % and the non-melting fibre content is at or about 50 wt %, based on the dry weight of the fibres before treatment with silicate (i.e. the dry weight of the total fibre content). In a further preferred embodiment, the melting fibre content is at or about 25 wt % and the non-melting fibre content is at or about 75 wt %, based on the dry weight of the fibres before treatment with silicate (i.e. the dry weight of the total fibre content).

It is particularly preferred to use a mixture of cellulose and polyester fibres, preferably wherein the mixture of cellulose to polyester fibre is at or about 50 wt % cellulose to at or about 50 wt % polyester fibre, particularly preferably wherein the mixture of cellulose to polyester fibre is at or about 46 wt % cellulose to at or about 54 wt % polyester fibre, based on the dry weight of the fibres before treatment with silicate (i.e. the dry weight of the total fibre content). A preferred mixture of fibres is a spun-laced mixture of wood pulp and polyester, preferably having the above proportions of wood pulp (cellulose) and polyester.

The expression “silicate” encompasses salts of silicic acid, particularly potassium silicate, sodium silicate, calcium silicate, magnesium silicate, and mixtures thereof. Sodium and potassium silicate are particularly preferred, separately or in mixture. The silicate is preferably applied to a mixture of the non-melting and melting fibres in the form of an aqueous solution or dispersion. Particularly preferred is potassium silicate (“KaSi”), preferably an aqueous solution or dispersion of potassium silicate.

The silicate content of the fireskin of the invention is preferably greater than at or about 20 wt %, more preferably greater than at or about 60 wt %, particularly preferably greater than at or about 75 wt %, based on the dry weight of the fireskin. In general, the higher the silicate content, the higher the heat- and flame-resistance. If fire-resistant fibres are used, such as aramid fibres, the silicate content can be lower.

When a composite panel laminate is made using the slurry or coagulation method, the silicate content of the panel laminate is preferably between at or about 50 to at or about 98 wt %, based on the dry weight of the laminate.

The fibres may be soaked in a silicate solution or dispersion, or the silicate may be applied to the surface of a sheet of fibres, for example by painting, spraying or application with rollers, particularly rollers with pressure, and allowed to penetrate the fibres. Advantageously, a surface-active agent or wetting agent may be added to the silicate solution or dispersion, thus enhancing penetration of the silicate into the fibre. Examples of suitable surface-active or wetting-agents are non-ionic surfactants, particularly sorbitol anhydride fatty acid esters (SPAN), non-ionic fatty acid ethoxylates (such as Tinovetin® 4483 jun, an non-ionic alkyl ethoxylate). The wetting agent is preferably present at not more than 0.20 wt %, based on the dry weight of the fireskin or laminate.

In a preferred embodiment, the fibres are embedded in a continuous web, which is passed through application rollers to which an aqueous silicate solution or dispersion is applied. Alternatively, the sheet of fibres, preferably a continuous web, is passed through a bath of an aqueous silicate solution or dispersion. After application of the silicate solution or dispersion, the sheet is passed through a drying process, such as an air drier. The continuous web may optionally be calendered, and if desired cut into smaller sheets. These methods permit a continuous online process for making fireskins of the invention. Any other non-fibre ingredients may be present in the silicate solution or dispersion, either dissolved or as a suspension, or they may be present in the sheet of fibres before application of the silicate solution.

In a preferred embodiment of the fireskins and laminates of the invention, particles of serpentine mineral are added to the mixture of the non-melting fibre, the melting fibre and the silicate. The expression “serpentine mineral” encompasses those minerals M₃T₂O₅(OH)₄ where M may be magnesium (Mg), ferrous iron (Fe²⁺), ferric iron (Fe³⁺), aluminium (Al), nickel (Ni), manganese (Mn), cobalt (Co), chromium (Cr), zinc (Zn), or lithium (Li); and T may be silicon (Si), Al, Fe³⁺, or boron (B). Advantageously serpentine minerals are used in which T is silicon. Particularly preferably serpentine minerals are used having the following formulae: Mg₃Si₂O₅(OH)₄ and Mg₃Si₄O₁₀(OH)₂, and mixtures of these, generating together with the alkali silicate a multi-silicate structure. Any material able to generate together with the alkali silicate a multi-silicate structure may be used.

The particles of serpentine mineral advantageously have a median particle size of between at or about 5 to at or about 200 micron, more preferably at or about 25-100 microns, particularly preferably at or about 44 microns.

When serpentine mineral particles are added, they are preferably present in a fireskin at or about 1 to 30 wt %, more preferably at or about 5 to 12 wt %, particularly preferably at or about 10 wt %, based on the total dry weight of the fireskin or laminate. An example of a preferred serpentine mineral is sold under the tradename Northfil® 325 (non-fibrous Magnesium silicate). Northfil® 325 has the following characteristics (other serpentine minerals having these characteristics are also suitable):

| Bulk Density | | |
|---|---|---|
| Loose | 0.708 | g/cm³ |
| Tapped | 0.891 | g/cm³ |
| pH (slurry in water) | 9.8 | |
| Oil absorption | 41.9 | g/100 g |
| Median particle size | 44 | micron |
| Water solubility | 0.0038 | g/100 ml |

The composites of the invention are advantageously used to make heat- and flame-resistant panels.

In a further embodiment, the invention provides a heat- and flame-resistant dual-component panel comprising:

at least one outer layer consisting of a sheet comprising a mixture of non-melting fibres and melting fibres and a silicate (i.e. a fireskin); and

a core layer comprising a mixture of non-melting fibres, optionally melting fibres, and a silicate.

The core layer preferably has a silicate content of at least 50 wt %, based on the dry weight of the layer, more preferably greater than at or about 60 wt %, particularly preferably greater than at or about 75 wt %, based on the dry weight of the layer. In some embodiments, the silicate content of the core layer is between at or about 90 to at or about 98 wt %, based on the dry weight of the layer. High silicate contents generally give better heat- and flame-resistance.

Such panels advantageously comprise two fireskins on either side of the core layer.

The fireskin or fireskins may be applied on one or both sides of the core layer using pressure and optionally heat. Advantageously, no organic binder is used, and the silicate in the fireskin serves to bond it to the surface of the core layer. Alternatively, an organic binder or glue may be used to bond the fireskin or fireskins to the surfaces of the core layer.

Heat and flame resistance of composites of the invention can be measured, for example using European norm 13823 [EN 13823].

Composites of the invention are advantageously used as construction panels for interior and exterior use. Such panels may be used for outdoor cladding, walls, ceilings, roofs, shutters, countertops, doors and floors. Such panels may be used in buildings, transport uses (planes, trucks, boats, buses, camping vehicles, etc.), and in furniture (e.g. tables, chairs).

Laminates may be decorated and/or coloured by painting, inclusion of pigments in the composite itself, or advantageously by electron beam treatment, as described in European patent application no. EP1122062.

Preferred embodiments of the composites of the invention are as follows:

Fireskins

Preferred fireskins comprise:

Non-melting fibre: at or about 50 to at or about 80 wt %, more preferably at or about 60 to at or about 80 wt %, based on the dry weight of total fibre content;

Melting fibre: at or about 10 to at or about 55 wt %, more preferably at or about 15 to at or about 40 wt %, particularly preferably at or about 25 to 35 wt %, based on the dry weight of total fibre content;

Silicate: at or about 30 to at or about 80 wt %, more preferably at or about 50 to at or about 75 wt % (preferably KaSi), based on the dry weight of the fireskin.

Laminates

Laminates of the invention may be made by stacking fireskins of the invention, and applying pressure and optionally heat. In this case, the composition of the laminate is essentially similar to the fireskins that are stacked to form the laminate. The stacking of any and all of the fireskins recited herein is contemplated.

Either a single type of fireskin may be stacked (i.e. all the stacked fireskins having essentially the same composition), to form a laminate having an essentially homogenous composition throughout its thickness, or different types of fireskin may be stacked, to form a laminate having a composition that varies across its thickness. For example, it may be desirable to use outer fireskins (i.e. those on the outside surfaces of the laminate) having a higher fire resistance, in which case fireskins having a relatively high silicate content (i.e. at or about 70 to 80 wt %) might be used for the outer layers. For the inner layers, if it is desired to have greater flexibility and/or resilience and/or reduced weight, in which case fireskins having a relatively high melting fibre content (i.e. greater than at or about 30 wt %, based on the based on the dry weight of total fibre content) and/or having a relatively low silicate content (i.e. less than at or about 60 wt %, based on the dry weight of the fireskin) might be used for the inner layers.

The use of different fireskins can allow the maker of the laminate to tailor the overall composition (i.e. silicate content, melting and non-melting fibre content) to the desired end use. It is equally possible to alternate different types of fireskin in a stack.

Composites Made by Slurry and Coagulation Methods

Composites of the invention may be made by forming a slurry of the mixed fibres and a silicate in water, pouring the slurry into a mould and drying.

Alternatively composites of the invention may be made by forming a slurry of the mixed fibres and a silicate in water, and adding this slurry to a water-miscible solvent, such as methanol, ethanol or propanol to form the composite as a coagulated mass.

In both cases, preferred compositions are as follows:

Non-melting fibre: at or about 45 to at or about 85 wt %, more preferably at or about 50 to at or about 65 wt %, based on the dry weight of total fibre content;

Melting fibre: at or about 15 to at or about 55 wt %, more preferably at or about 35 to at or about 50 wt %, based on the dry weight of total fibre content;

Silicate: at or about 30 to at or about 85 wt %, more preferably at or about 50 to at or about 75 wt % (preferably KaSi), based on the dry weight of the composite.

Non-melting fibre: at or about 45 to at or about 85 wt %, more preferably at or about 50 to at or about 65 wt %, based on the dry weight of total fibre content;

Melting fibre: at or about 15 to at or about 55 wt %, more preferably at or about 35 to at or about 50 wt %, based on the dry weight of total fibre content;

Silicate: at or about 85 to at or about 98 wt %, more preferably at or about 90 to at or about 98 wt % (preferably KaSi), based on the dry weight of the composite.

Dual-Component Panels

Such panels comprise one or two fireskins as any of the above, applied to one or both sides of a core layer, wherein the core layer comprises:

Non-melting fibre: at or about 50 to at or about 100 wt %, more preferably at or about 60 to at or about 100 wt %, based on the dry weight of total fibre content;

Melting fibre: at or about 0 to at or about 50 wt %, more preferably at or about 0 to at or about 40 wt %, based on the dry weight of total fibre content;

Silicate: at or about 50 to at or about 98 wt %, more preferably at or about 60 to at or about 98 wt % (preferably KaSi), based on the dry weight of the core layer.

Alternatively, the core layer may have the composition of the laminates recited above, or it may have the composition of any of the composites made by the slurry or coagulation methods recited above. Equally, the core layer may consist of cellular concrete, or of a composite made using conventional technology, i.e. comprising non-melting fibre and organic resins.

### EXAMPLES

### Example 1

### Fireskins

Fireskins were made to contain various amounts of melting (polyester, polyethylene terephthalate) and non-melting fibres (wood or cotton fibre), according to the compositions listed in Table 1. The polyester and wood fibres were spun-laced.

Those composites containing only non-melting fibre (Samples 1 and 12) and those composites containing only melting fibre (Samples 2 and 3), were made for comparative purposes. Comparative Samples are shaded in Table 1.

The fibres were in the form of sheets, having an average thickness of 0.3 mm (range 0.2 to 0.6 mm), before application of silicate. The weight per unit area is reported in Table 1. The sheets were padded with an aqueous solution or dispersion containing the non-fibre components, by passing the fibre sheets through application rollers (the sheets can equally well be passed through a bath of the silicate solution or dispersion). The resulting silicate impregnated sheets were dried by passing through hot air, to yield the fireskins and Comparative Samples listed in Table 1.

TABLE 1
Compositions of fireskins of the invention (shaded columns are comparative)

| | Sample no. | | | | | | | |
|---|---|---|---|---|---|---|---|---|
| | 1 | 2 | 3 | 4 | 5 | 9 | 12 | 15 |
| Fibres (wt %'s | 100 wt % | 100 wt % | 100 wt % | 54 wt % | 25 wt % | 54 wt % | 100 wt % | 54 wt % |
| are based on | cotton | spun-laced | spun-laced | polyester; | polyester; | polyester; | cotton | polyester; |
| the total fibre | 155 g/m² | polyester | polyester | 46 wt % | 75 wt % | 46 wt % | 155 g/m² | 46 wt % |
| content) | | 65 g/m² | 65 g/m² | wood; spun- | wood; spun- | wood; | | wood; |
| | | | | laced | laced | spun-laced | | spun-laced |
| | | | | 123 g/m² | | 123 g/m² | | 123 g/m² |
| Silicate and | KaSi¹ | KaSi | KaSi | KaSi | KaSi | KaSi 90 wt %; | KaSi 90 wt %; | KaSi 95 wt %; |
| other non- | | | | | | Northfil 325² | NaSi | Northfil 325 |
| fibre | | | | | | 10 wt % | 10 wt % | 5 wt % |
| constituents | | | | | | | | |
| (wt %'s based | | | | | | | | |
| on total non- | | | | | | | | |
| fibre content) | | | | | | | | |
| Fibre/Silicate | 45/55 | 27/73 | 46/54 | 33/67 | 40/60 | 29/71 | 41/59 | 32/68 |
| and non- | | | | | | | | |
| fibre | | | | | | | | |
| Dry fireskin | 340 | 245 | 140 | 374 | 357 | 425 | 374 | 391 |
| weight | | | | | | | | |
| (g/m²) | | | | | | | | |

¹KaSi = potassium silicate; NaSi = sodium silicate
²Northfil = Northfil is the trade name of a non-fibrous Magnesium silicate, serpentine powder, having the formula Mg₃Si₂O₅(OH)₄ and Mg₃Si₄O₁₀(OH)₂, and mixtures of these

### Example 2

### Laminates

The fireskins made as above were stacked to varying thickness and pressed at 160° C. and 75 bars pressure to form laminates. The number of layers, the length of time of pressing (minutes), and the thickness (mm) after pressing are indicated in Table 2. Shaded columns indicate comparative laminates (i.e. prior art).

TABLE 2
Laminates made by stacking fireskins of Table 1
(Sample Nos. correspond to the fireskins of
Example 1 used) (shaded columns are comparative)

| | Sample no. | | | | | | | |
|---|---|---|---|---|---|---|---|---|
| | 1 | 2 | 3 | 4 | 5 | 9 | 12 | 15 |
| Number of | 30 | 60 | 60 | 30 | 15X | 30 | 30 | 30 |
| layers | | | | | Sample 1 | | | |
| | | | | | 15X | | | |
| | | | | | Sample 4 | | | |
| Pressing | 15 | 15 | 15 | 30 | 30 | 30 | 30 | 30 |
| time in | | | | | | | | |
| minutes | | | | | | | | |
| (160° C., | | | | | | | | |
| 75 Bar) | | | | | | | | |
| Thickness | 5.7 | 6.4 | 5.4 | 6.0 | 5.9 | 6.6 | — | 6.2 |
| after | | | | | | | | |
| pressing | | | | | | | | |
| (mm) | | | | | | | | |

### Example 3

### Heat and Flame Resistance Test

The laminates of Example 2 were tested for heat and flame resistance as follows:

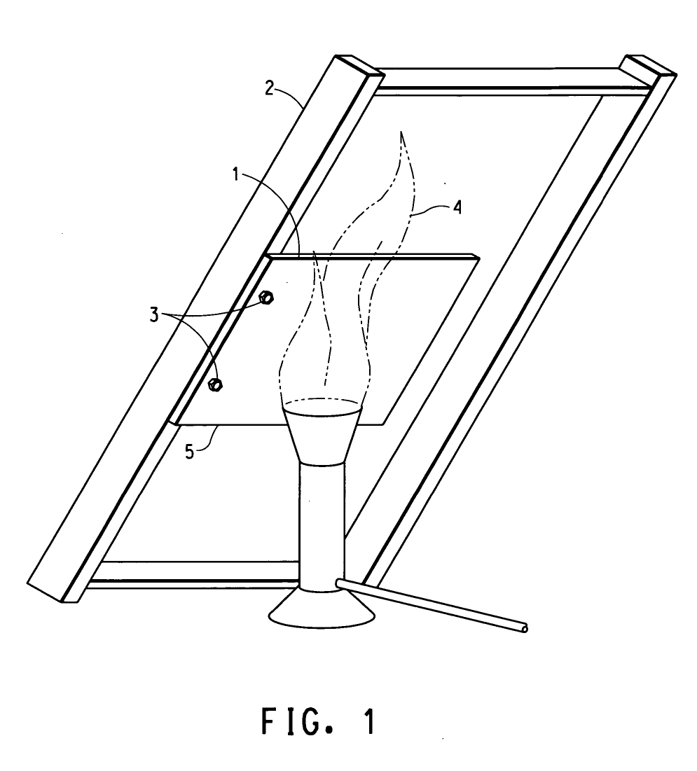

The experimental set-up illustrated in FIG. 1 was used. The sample holder was based on European Norm 532 (EN 532) and the burner was based on European Norm 367 (EN 367). The sample laminate (1) was a rectangular piece (15×10 cm, height×width). It was held onto metal brace (2) with two screws (3) on the left hand side of the sample (the right hand side was not held), and inclined at an angle 30° from the vertical. A propane flame (4) of 80 KW (kilowatts) was directed at the inclined sample (1) in such a way that the lower part of the flame touched the sample 1 cm above the lower edge (5) of the sample. The flame was maintained for 20 minutes and the following observations were made:
fume description (colour, density, time)
flame height and duration (cm and minutes)
panel dimensional stability (bowing, bending, swelling)
core behaviour (delamination, burning, carbonisation, pyrolysis, etc)
degradation (carbonisation, burning, etc)
time until flame reaches the lower edge (minutes)
behaviour of backside (burning, carbonisation, degraded area, etc.)

After the flame was removed, the sample was observed for two minutes and the following were noted:
time of afterglow
time of afterburn
physical degradation

Based on the observations in the above test, the samples were assigned ratings of 1-10. The best heat- and flame-resistant rating is 10, the worst 1. The ratings of the laminates of Example 2 are listed in Table 3. Shaded columns indicate comparative laminates (i.e. prior art).

Effect of Melting and Non-Melting Fibre

The effect of adding melting fibre can be seen by comparing the ratings of Comparative Sample 1 and Inventive Sample 5. Comparative Sample 1, according to the prior art, has only non-melting fibre (100 wt % cotton), whereas Inventive Sample 5 was a blend of 25 wt % melting fibre (polyester) and 75 wt % non-melting fibre (wood pulp). Both Samples 1 and 5 have a similar silicate content (55 wt % for Sample 1 and 60 wt % for Sample 5). Inventive Sample 5, containing melting and non-melting fibre, has a rating of 9, whereas Comparative Sample 1, having only non-melting fibre, has a rating of 5.

Similarly, Comparative Sample 2 has only melting fibre (polyester), whereas Inventive Sample 4 was a blend of 54 wt % melting fibre (polyester) and 46 wt % non-melting fibre (wood pulp). Both Samples 2 and 4 have similar silicate content (73 wt % for Sample 2 and 67 wt % for Sample 4). Inventive Sample 4, having a blend of melting and non-melting fibre, has a rating of 8, whereas Comparative Sample 2, having only melting fibre, has a rating of 4.

Similarly, Comparative Sample 3 has only melting fibre (polyester), whereas Inventive Sample 5 was a blend of 25 wt % melting fibre (polyester) and 75 wt % non-melting fibre (wood pulp). Both Samples 3 and 5 have similar silicate content (54 wt % for Sample 3 and 60 wt % for Sample 5). Inventive Sample 5, having a blend of melting and non-melting fibre, has a rating of 9, whereas Comparative Sample 3, having only melting fibre, has a rating of 6.

TABLE 3
Flame test ratings of laminates of Example 2 (shaded columns
are comparative)

Sample no.

| | 1 | 2 | 3 | 4 | 5 | 9 | 12 | 15 |
|---|---|---|---|---|---|---|---|---|
| Overall | 5 | 4 | 6 | 8 | 9 | 8 | 5 | 8 |
| rating in | | | | | | | | |
| flame test | | | | | | | | |
| 1-worst | | | | | | | | |
| 10-best | | | | | | | | |

What is claimed is:

1. A method for making a fire-resistant composite, comprising the step:
applying a silicate solution or dispersion to an intimate mixture of a non-melting fibre and a melting fibre.

2. The method of claim 1, wherein the non-melting fibres are selected from cellulose, wool, silk, aramids, polybenzimidazoles, polyimides, polyarenes, rayon, and mixtures of these.

3. The method of claim 1, wherein the melting fibres are selected from polyester, mixed polyetheresters, polyamide, polyolefins, polyphenylene sulfide (PPS), polyethertherketone (PEEK), poly(ether ketone ketone) (PEKK), PFA (copolymer of tetrafluoroethylene and perfluorovinylether), FEP (copolymer of tertafluoroethylene and hexafluoropropylene), melt spun fluorofibres (homopolymer of tetrafluoroethylene), glass or basalt fibres, and mixtures of these.

4. The method of claim 1, wherein the non-melting fibres are cellulose fibres and the melting fibres are polyester fibres.

5. The method of claim 1, wherein the silicate is potassium silicate, sodium silicate, or a mixture of alkali silicates.

6. The method of claim 1, additionally comprising the step of adding particles of serpentine mineral.

7. The method of claim 1, wherein the silicate is present at or about 50 to at or about 98 wt %, based on the weight of the composite.

8. The method of claim 1, wherein the melting fibres are used at or about 10 to at or about 55 wt %, based on the dry weight of the total fibre content.

9. The method of claim 1, wherein the fibres are in the form of a sheet having a thickness of not more than at or about 1 mm.

10. A method for making a heat- and flame-resistant composite laminate, comprising the steps:
(a) stacking a plurality of composites according to claim 1, to form a stack; and
(b) applying pressure and optionally heat to the stack to form a laminate.

11. A method for making a heat- and flame-resistant composite laminate, comprising the step:
applying pressure and optionally heat to a stack of two or more composites according to claim 1.

12. A method for making a heat- and flame-resistant composite comprising the step:
drying a slurry comprising:
non-melting fibres;
melting fibres;
at least one silicate; and
water.

13. A method according to claim 12, wherein the non-melting fibres are selected from cellulose, wool, silk, aramids, polybenzimidazoles, polyimides, polyarenes, rayon, and mixtures of these.

14. The method of claim 12, wherein the organic melting fibres are selected from polyester, mixed polyetheresters, polyamide, polyolefins, polyphenylene sulfide (PPS), polyethertherketone (PEEK), poly(ether ketone ketone) (PEKK), PFA (copolymer of tetrafluoroethylene and perfluorovinylether), FEP (copolymer of tetrafluoroethylene and hexafluoropropylene), melt spun fluorofibres (homopolymer of tetrafluoroethylene), glass or basalt fibres, and mixtures of these.

15. The method of claim 12, wherein the non-melting fibres are cellulose fibres and the melting fibres are polyester fibres.

16. The method of claim 12, wherein the silicate is potassium silicate, sodium silicate, or a mixture of alkali silicates.

17. The method of claim 12, wherein the slurry additionally comprises particles of serpentine mineral.

18. The method of claim 12, wherein prior to the step of drying, the slurry is moulded in a mould.

19. The method of claim 12, wherein the drying is accomplished by microwave heating.

20. A method for making a heat- and flame-resistant composite comprising the step:
adding a slurry comprising non-melting fibres, melting fibres, a silicate, and water to a water-miscible organic solvent, to form the composite as a coagulated mass.

21. A method according to claim 20, wherein the non-melting fibres are selected from cellulose, wool, silk, aramids, polybenzimidazoles, polyimides, polyarenes, rayon, and mixtures of these.

22. The method of claim 20, wherein the organic melting fibres are selected from polyester, mixed polyetheresters, polyamide, polyolefins, polyphenylene sulfide (PPS), polyethertherketone (PEEK), poly(ether ketone ketone) (PEKK), PFA (copolymer of tetrafluoroethylene and perfluorovinylether), FEP (copolymer of tetrafluoroethylene and hexafluoropropylene), melt spun fluorofibres (homopolymer of tetrafluoroethylene), glass or basalt fibres, and mixtures of these.

23. The method of claim 20, wherein the non-melting fibres are cellulose fibres and the melting fibres are polyester fibres.

24. The method of claim 20, wherein the silicate is potassium silicate, sodium silicate, or a mixture of alkali silicates.

25. The method of claim 20, wherein the slurry additionally comprises particles of serpentine mineral.

26. The method of claim 20, wherein the drying is accomplished by microwave heating.
